(19) United States
(12) Patent Application Publication
(10) Pub. No.: US 2008/0288890 A1
(43) Pub. Date: Nov. 20, 2008

(54) Multimedia presentation authoring and presentation

(75) Inventors: Gary Anderson, Arden Hills, MN (US); Yonglin Li, Oakdale, MN (US)

Correspondence Address: SCHWEGMAN, LUNDBERG & WOESSNER, P.A., P.O. BOX 2938, MINNEAPOLIS, MN, 55402, US

(73) Assignee: Netbriefings, Inc, St. Paul, MN (US)

(21) Appl. No.: 12/152,472

(22) Filed: May 14, 2008

Related U.S. Application Data
(60) Provisional application No. 60/938,043, filed on May 15, 2007.

(51) Int. Cl. G06F 17/30; G06F 3/048

(52) U.S. Cl. 715/810; 707/104.1; 707/10; 707/E17.009

(57) ABSTRACT

Various embodiments include one or more of systems, methods, software, data structures, and user interfaces for recording and delivery of multimedia presentations. Some embodiments include simultaneous recording of video and capturing of identifiers of other media elements selected for display from a playlist relative to time positions within the recorded video.

### RELATED APPLICATION(S)

This application claims the benefit of priority under 35 U.S.C. 119(e) to U.S. Provisional Patent Application Ser. No. 60/938,043, filed May 15, 2007, which is incorporated herein by reference.

### BACKGROUND INFORMATION

Seminars, training, meetings, and other events where information is presented traditionally have been face to face at a single location. As businesses and other organizations have expanded into national and international efforts, the expense of conducting such meetings in a single location has become prohibitive.

Previous efforts have provided peer-to-peer video conferencing over dedicated phone lines and the Internet between members of a small group. Other efforts have provided broadcast of slide presentations to several people or groups. However, these efforts, although highly utilized, fail to provide mechanisms by which full multimedia presentations may be broadcast. Further, recording of such presentations for later viewing has required additional effort to synchronize presented material.

### BRIEF DESCRIPTION OF THE DRAWINGS

FIG. 1 is a block diagram of a system according to an example embodiment.

FIG. 2 is a user interface illustration according to an example embodiment.

FIG. 3 is a user interface illustration according to an example embodiment.

FIG. 4 is a data structure illustration according to an example embodiment.

FIG. 5 is a user interface illustration according to an example embodiment.

FIG. 6 is a user interface illustration according to an example embodiment.

FIG. 7 is a user interface illustration according to an example embodiment.

FIG. 8 is a data structure illustration according to an example embodiment.

FIG. 9 is a user interface illustration according to an example embodiment.

FIG. 10 is a block flow diagram of a method according to an example embodiment.

FIG. 11 is a block flow diagram of a method according to an example embodiment.

FIG. 12 is a block flow diagram of a method according to an example embodiment.

FIG. 13 is a block diagram of a computing device according to an example embodiment.

### DETAILED DESCRIPTION

In the following detailed description, reference is made to the accompanying drawings that form a part hereof, and in which is shown by way of illustration specific embodiments in which the inventive subject matter may be practiced. These embodiments are described in sufficient detail to enable those skilled in the art to practice them, and it is to be understood that other embodiments may be utilized and that structural, logical, and electrical changes may be made without departing from the scope of the inventive subject matter. Such embodiments of the inventive subject matter may be referred to, individually and/or collectively, herein by the term “invention” merely for convenience and without intending to voluntarily limit the scope of this application to any single invention or inventive concept if more than one is in fact disclosed.

The following description is, therefore, not to be taken in a limited sense, and the scope of the inventive subject matter is defined by the appended claims.

The functions or algorithms described herein are implemented in hardware, software or a combination of software and hardware in one embodiment. The software comprises computer executable instructions stored on computer readable media such as memory or other type of storage devices. Further, described functions may correspond to modules, which may be software, hardware, firmware, or any combination thereof. Multiple functions are performed in one or more modules as desired, and the embodiments described are merely examples. The software is executed on a digital signal processor, ASIC, microprocessor, or other type of processor operating on a system, such as a personal computer, server, a router, or other device capable of processing data including network interconnection devices.

Some embodiments implement the functions in two or more specific interconnected hardware modules or devices with related control and data signals communicated between and through the modules, or as portions of an application-specific integrated circuit. Thus, the exemplary process flow is applicable to software, firmware, and hardware implementations.

Various embodiments provide a personal multimedia communication tool. Some such embodiments utilize Flash technology available from Adobe Corporation of San Jose, Calif. Using this tool, it is possible to broadcast live presentations and to record presentations and make them available on demand. These presentations may include audio and video broadcast in a synchronized manner with other media that is simultaneously displayed or presented, such as slide presentations, video, audio, and other media types.

These embodiments allow quick, inexpensive, and easy broadcast and presentation of information to a large number of people, geographically separated groups, and others that are difficult or cost prohibitive to have in a single location at the same time. In some embodiments, a presentation may include multiple presenters. Video, audio, slide shows, such as slides of a Microsoft PowerPoint presentation, and other content may be transmitted to a moderator who may then select the content to be broadcast.

To facilitate broadcast of slide presentations, video, and other multimedia content, the content is uploaded to a server. A moderator or presenter may then view a listing of the available content in a presenter view through a web browser based interface. The presenter or moderator may order content in a playlist for inclusion in a broadcast or archived presentation. In some embodiments, the presenter or moderator may select the content of the playlist to be displayed sequentially. In other embodiments, a presenter or moderator selects the content within the playlist when needed in the context of a conversation or presentation.

In further embodiments, video of not only a presenter is presented in a webcast presentation, but also video of one or more participants may be presented. In such embodiments, video of a participant asking a question or otherwise contributing to the presentation may be displayed. In such embodiments, video may be received from a webcam of the participant and rebroadcast by a moderator or designated by a moderator for peer-to-peer transmission from a participant to other participants.

Some embodiments also include instant messaging capabilities to allow participants to ask questions, share information, and communicate with the presenter, moderator, and other participants.

After a presentation is broadcast live or recorded, the presentation, including audio, video, and other multimedia content such as slide presentations, videos, and the like may be archived and made available on demand. In some embodiments, the presentation may be archived as a podcast and made available for download to a computer or portable multimedia device. These and other embodiments are described and illustrated herein with reference to the figures.

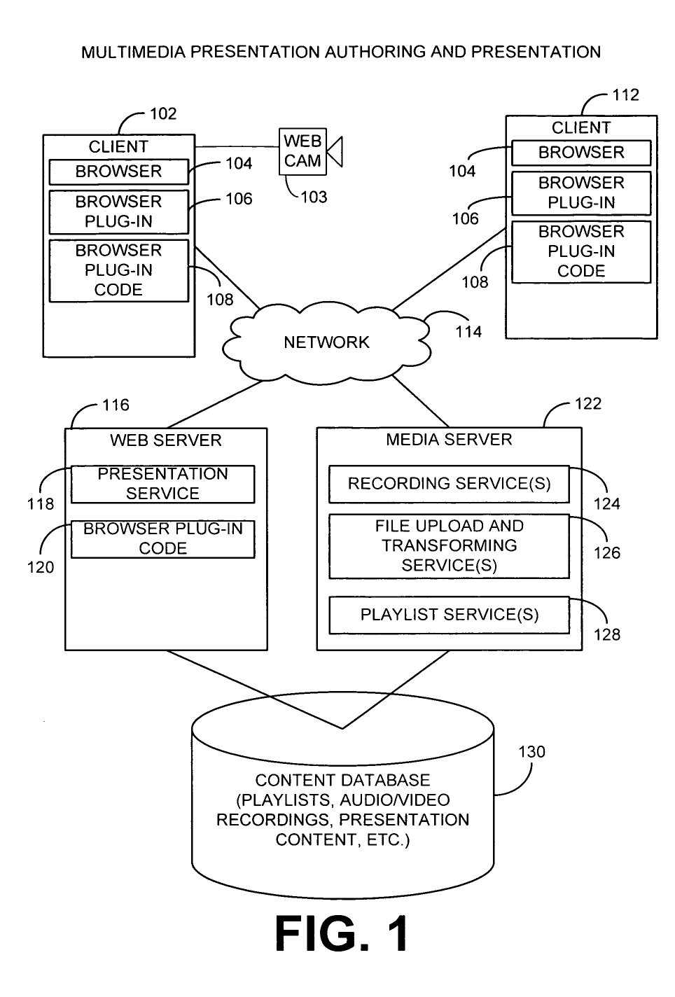

FIG. 1 is a block diagram of a system according to an example embodiment. The system includes two clients 102, 112 connected to a network 114. Also connected to the network 114 are a web server 116 and a media server 122.

The clients 102, 112 both include a web browser 104, such as Internet Explorer available from Microsoft Corporation of Redmond, Wash., Safari available from Apple, Inc. of Cupertino, Calif., or other web browsing application. The client 102, 112 also both include a browser plug-in 106. The browser plug-in 106, in some embodiments, is a FLASH Player plug-in available from Adobe Corporation. However in other embodiments, the plug-in 106 may be a Silverlight plug-in available from Microsoft Corporation, a QuickTime Player plug-in available from Apple, Inc., or other media player type plug-in. In some embodiments, the client 102 is a client computer of a presentation presenter or moderator. In such embodiments, the client 102 includes a web cam 103 to capture audio and video of a presenter. In some embodiments, the client 112 and other clients that may be connected to the network 114 may also include a web cam.

As used herein, the term presenter is used interchangeably with the term moderator. Thus, the terms presenter and moderator should be construed similarly unless explicitly provided otherwise.

As illustrated, the client 102 is a client of a presenter. In such embodiments, a user of the client 102, when wanting to generate a recorded presentation, causes the web browser 104 of the client 102 to connect to one or both of the media server 122 and the web server 116 over the network 114. The web browser 104 will download browser plug-in code 120 from the web server 116 and cache the browser plug-in code 108 on the client 102, 112. The browser plug-in code 108 is operable within the browser 104 to instantiate the browser plug-in 106 within the web browser 104. The browser plug-in code 108 may include ActionScript which is operable within a Flash Player plug-in. However, the browser plug-in code 108 may be other types of code or script depending on the browser plug-in and media server 122 services implemented in a particular embodiment.

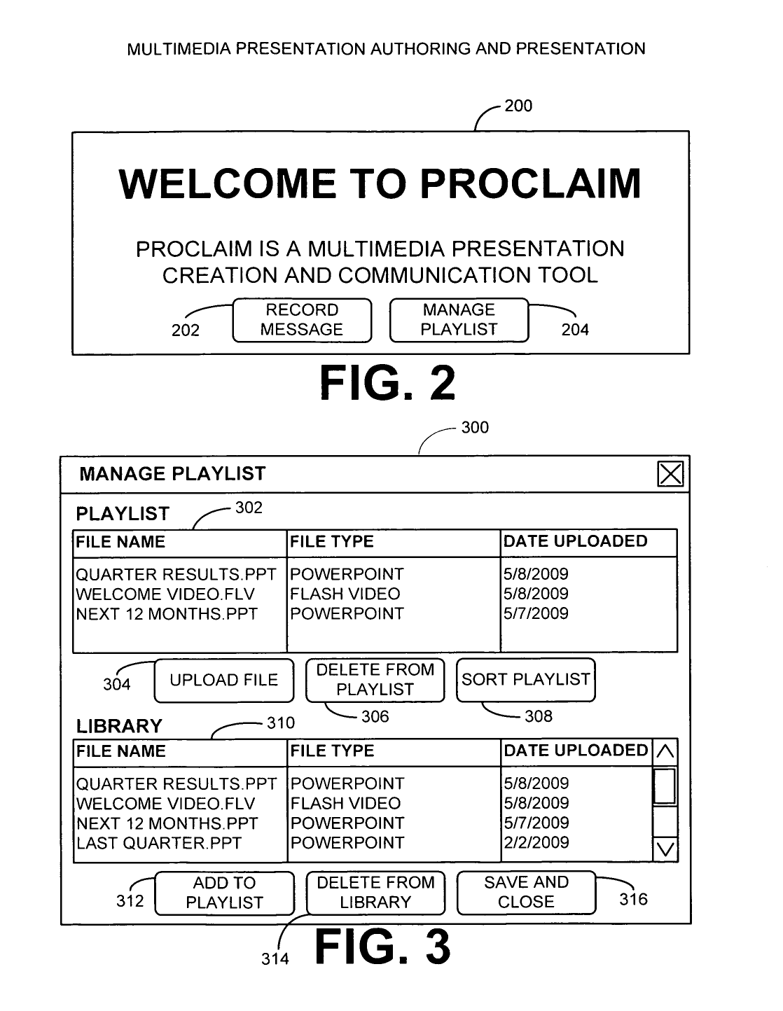

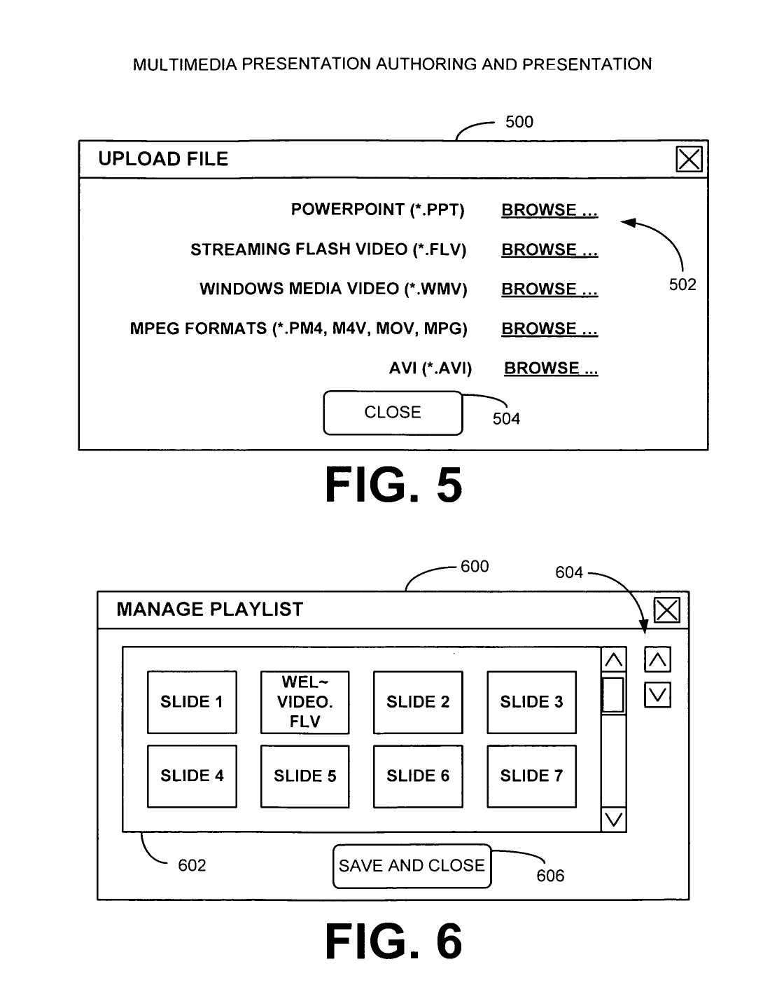

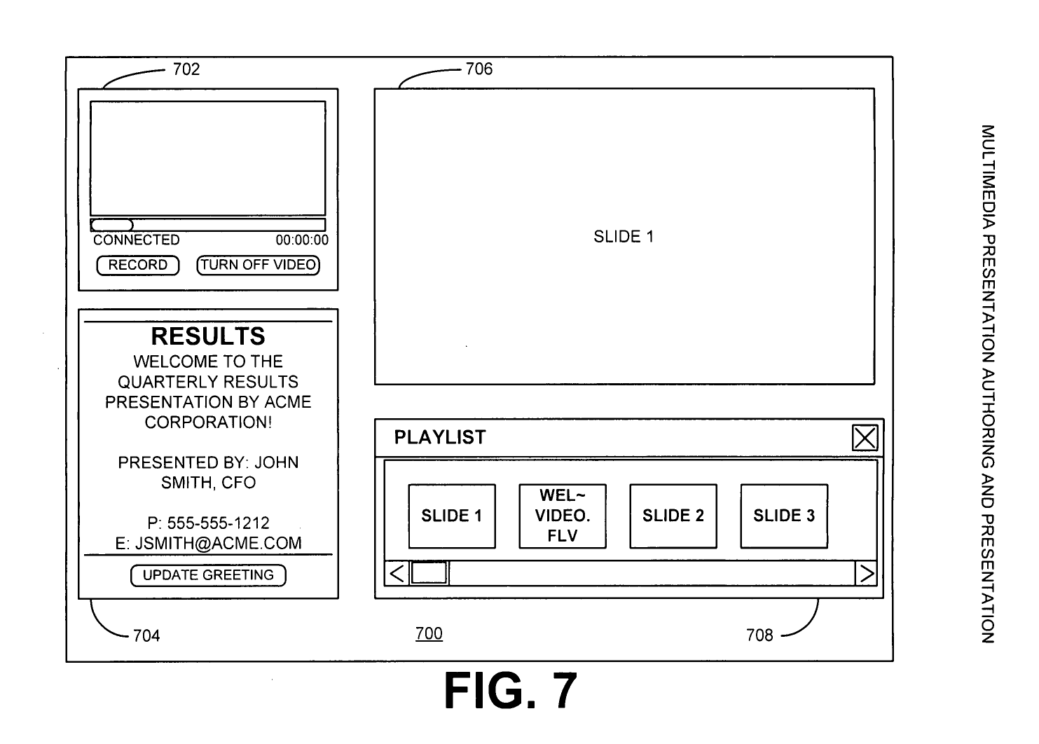

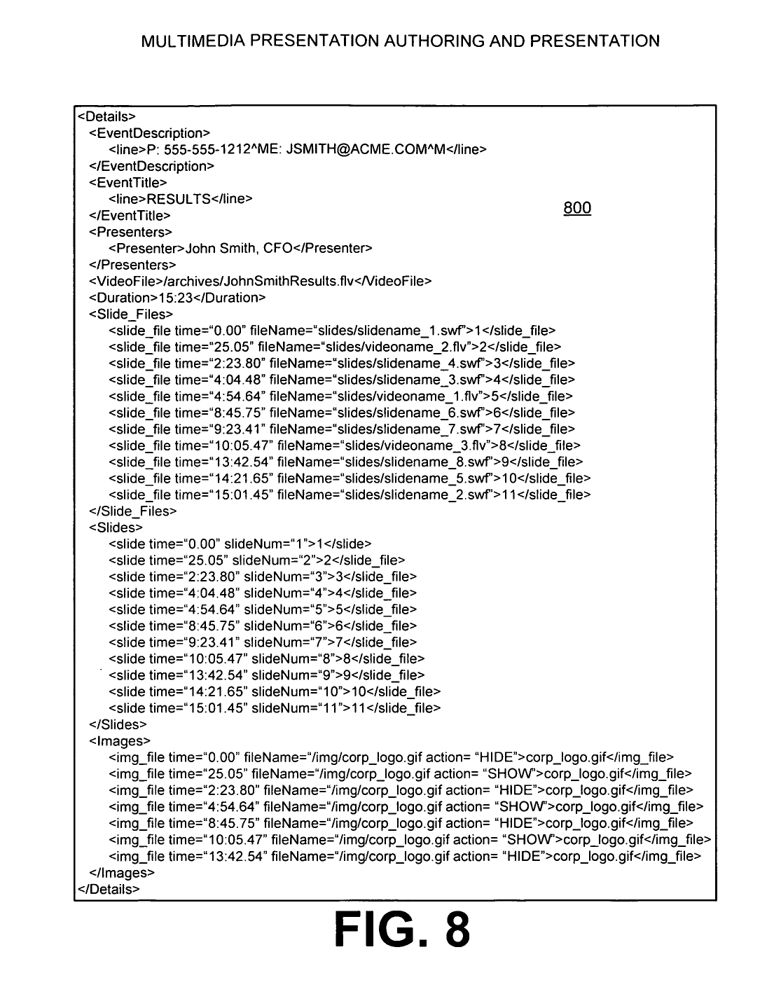

The browser plug-in code 108 is operable within the browser plug-in 106 to generate and present user interfaces to the client 102 user. Example of such user interfaces are provided in FIG. 2, FIG. 3, FIG. 5, FIG. 6, and FIG. 7, and FIG. 8, and will be described below. Such user interfaces are operable to receive input from a presenter while authoring a recorded presentation. The browser plug-in code 108 is further operable to communicate some or all of the received input over the network to the media server 122.

The media server 122, in some embodiments, provides services that may be called by browser plug-in code 108 on the clients 102, 112. The services that the media server 122 provides may include one or more presentation recording services 124, one or more file upload and transforming services 126, one or more playlist services 128, and other services depending on the particular embodiment.

The recording services 124 are operable on the media server 122 to receive various types of media and over data over the network 114 from one or more of the clients 102, 112. In some embodiments, the recording services 124 are operable to receive audio and video data, synchronization data that synchronizes presented materials, such as slides of a slide presentation, with the audio and video data, and other data. This data, when received for a particular presentation, may be stored in a content database 130 in an associative manner with other data of the particular presentation.

The file upload and transforming services 126 include services to receive presentation content files from a presenter, such as from the client 102, and to store the presentation content files in the content database 130. However, in some embodiments, the presentation content files may be received from the client 102 in a form that is not compatible for display with the client 102, 112 browser plug-ins 106. In such embodiments, the file upload and transforming services 126 are operable to receive presentation content files in various formats and transform them into a format that is compatible with the browser plug-in 106. For example, a video may be uploaded to the content database 130 via the file upload and transforming services. However, the video may be received from the client 102 in a format that is not compatible with the browser plug-in, such as in an MPEG format. The video file may be transformed by the file upload and transforming services 126 into a format, such as the FLV Flash video format which is compatible with the Flash Player plug-in. This transformation may be performed using one of may video transformation services that are provided in various software packages. One such example is available from the FFMPEG group at http://ffmeg.mplayerhq.hu.

In some embodiments, documents, such as slide presentation, word processing documents, and other document types, may also be converted to a format that is compatible for display within the browser plug-in 108. For example, in embodiments where the browser plug-in 108 is a Flash Player plug-in, each page of the document may be converted to the Portable Document Format (“PDF”) as set by Adobe Corporation using an Adobe Acrobat program on the media server 122. Each page converted to the PDF format may then be transformed into an image, such as a SWF image that is compatible with the Flash Player plug-in. This transformation may be performed using tools available from Adobe Corporation or other tools such as the pdf2swf software tool available at http://www.swftools.org. The converted video and document pages may are then stored in the content database 130.

The playlist services 128 are operable on the media server 122 are containers for content held in the content database 130. In some embodiments, a presenter, such as a user of the client 102, may generate a playlist including content that the user uploaded to the content database 130. The playlist may include images of slides, such as SWF images generated from a Microsoft PowerPoint presentation document uploaded via the file upload and transforming servers 126, and images of other documents. The playlist may also include videos uploaded to the content database and other content types.

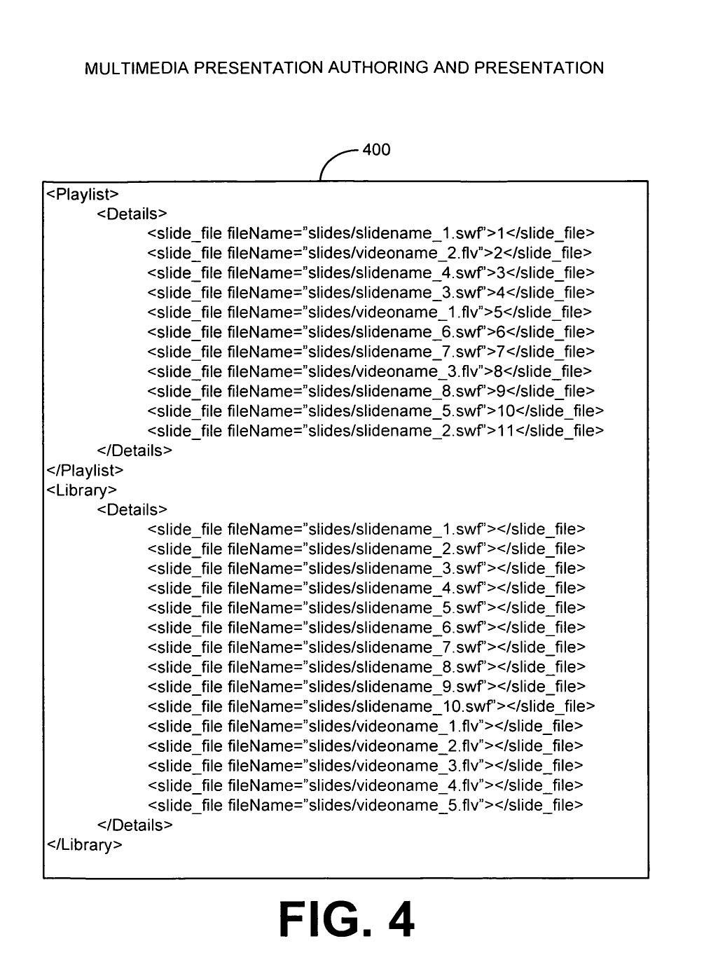

Such a playlist may be presented on the client 102 within the web browser 104 browser plug-in 106 using a portion of the browser plug-in code 108. The playlist when presented to the client 102 user may allow the user to specify an order of the content within the playlist. Data representative of that order may be communicated to the playlist services 128 and stored in the content database 130 or other location accessible to the media server 122. The playlist services 128 are also operative to perform other functions as will be apparent in view of later portions of this disclosure, such as with regard to the description of FIG. 3, FIG. 4, FIG. 6, and FIG. 7.

The web server 116 is operable to communicate with the clients 102, 112 over the network 114 to provide browser plug-in code 120, presentation services 118, to serve data from the content database 130, and other purposes. In some embodiments, if a client 112 user wishes to view a recorded presentation, the client 112 browser requests a presentation from the web server 116. The web server 116 provides the browser plug-in code 120 to the client 112 which locally caches the browser plug-in code 108 and executes the browser plug-in code 108 within the browser plug-in 106. The web server 116 via the presentation services 118 then retrieves the recorded presentation from the content database 130 and transmits it to the client 112 for presentation to the user of the client 112. The presentation may be retrieved from the content database 130 and provided to the client 112 in various ways. In one embodiment, a configuration file is retrieved and sent to the client 112. The configuration file may include data identifying a presenter video of a presenter to display in a first portion of a presentation viewing interface and identify content images and videos to display in a second potion of the presentation viewing interface at particular times with regard to the presenter video. The browser plug-in code may parse this configuration file and retrieve the presenter video display the video in the first portion of the presentation viewing interface. The browser plug-in may further retrieve the content images and video and display them in the second portion of the presentation viewing interface at the respective identified times during the playing of the presenter video.

FIG. 2 is a user interface 200 illustration according to an example embodiment. The user interface 200 is an example of a user interface a presenter may receive when accessing a media server to setup or record a presentation. Such a user interface may provide two or more options to the presenter. These may be selected via action buttons 202, 204 which include a “RECORD MESSAGE” action button 202 and a “MANAGE PLAYLIST” action button 204. Selection of the “RECORD MESSAGE” action button 202 causes a user interface that allows the presenter to record a presentation to be displayed, such as the user interface of FIG. 7. The user interface of FIG. 7 is discussed below. Selection of the “MANAGE PLAYLIST” action button 204 causes a user interface that allows the presenter to manage a playlist to be displayed, such s that user interface of FIG. 3.

FIG. 3 is a user interface 300 illustration according to an example embodiment. The user interface 300 provides a view of a playlist 302 and a view of a library 310. The library view 310 includes a listing of all files a particular presenter has uploaded or otherwise has access to on a media server or in a content database. The playlist view 302 is a listing of files the presenter has setup for inclusion in a presentation.

The user interface 300 includes action buttons 304, 306, 308, 312, 314, 316 that provide playlist 302 and library 312 management functions. To upload a file to the playlist 302, the “UPLOAD FILE” action button 304 may be selected. Selection of the “UPLOAD FILE” action button 304, in some embodiments, may cause the user interface of FIG. 5 to be displayed. The user interface of FIG. 5 will be discussed below. In some other embodiments, a user interface of the web browser or an operating system may be opened and allow the presenter to select files for upload to the content database and inclusion in the playlist 302 and the library 310.

Selection of the “DELETE FROM PLAYLIST” action button 306 causes a file selected in the playlist 302 to be removed from the playlist 302. However, the file will remain in the library 310. In some embodiments, a file included in the playlist 302 is also included in the library 310. However, in some such embodiments, when a file is selected for inclusion in the playlist 302, the file will be hidden from view in the library 310 to prevent confusion to the presenter that might arise if a file is scrolled out of view in the playlist 302 and viewable in library 310.

Selection of the “SORT PLAYLIST” action button 308 may cause the user interface of FIG. 6 to be displayed. This user interface provides a view of images of individual document pages, such as individual slides of a slide presentation, and provides mechanisms by which the images may be sorted. The user interface of FIG. 6 will be described below.

Selection of the “ADD TO PLAYLIST” action button 312 adds a file selected in the library 310 to the playlist. Selection of the “DELETE FROM LIBRARY” action button 314 removes a file selected in the library from the library 310 and from the content database. Selection of the “SAVE AND CLOSE” action button 316 saves all change made to the playlist 302 and library 310, closes the user interface 300, and returns the presenter to the user interface 200 of FIG. 2.

FIG. 4 is a data structure 400 illustration according to an example embodiment. The data structure 400 identifies files stored in the content database and associates those files with a playlist and library of a presenter. The data structure 400 is retrieved by or provided to the user interface 300 of FIG. 3. The user interface 300 of FIG. 3 is also operable to modify and save the data structure 400.

FIG. 5 is a user interface 500 illustration according to an example embodiment. The user interface 500 may be displayed to a presenter when the presenter selects the “UPLOAD FILE” action button 304 of FIG. 3. The user interface 500 provides mechanisms by which the presenter may upload files to the content database for inclusion in the presenter's library 310 and playlist 302 as discussed above with regard to FIG. 3.

The user interface 500 may provide several file upload options 502 based on the type of file to be uploaded. For example, the presenter may want to upload a Microsoft PowerPoint slide presentation document. Selection of this option will provide a user interface that allows the presenter to navigate through a drive/folder/file organization on the presenters local computing device and network storage locations to select the appropriate file to upload. Once the file is selected, the file will be uploaded using the file upload and transformation services on the media server, as discussed above with regard to FIG. 1, and the individual slides of the slide presentation document will be transformed to an appropriate format, stored in the content database, and made available in the presenter's library and playlist. Once the presenter is finished uploading documents and videos with the user interface 500, the “CLOSE” action button 504 may be selected which will cause the user interface 500 to close. The presenter will be returned to the user interface 300 of FIG. 3.

FIG. 6 is a user interface 600 illustration according to an example embodiment. The user interface 600 provides a content detail view 602 of individual slide images, graphic files, video files, and other file and image types within a playlist of the presenter. The user interface 600 allows a presenter to sort the content included in playlist. For example, the presenter may select SLIDE 1 and move it around using drag-and-drop functionality and or action buttons 604 to move the slide up or down in order. The order of the content set in the user interface 600 set the order of the content when the presenter is in a recording user interface, such as the user interface of FIG. 7.

FIG. 7 is a user interface 700 illustration according to an example embodiment. The user interface 700 is used by a presenter to record to a presentation. The user interface 700 includes a video recording portion 702, an greeting portion 704, a content viewing portion 706, and a playlist portion 708.

The video portion includes a video viewing area that displays video captured by a video camera attached to the presenter's computer. The video recording portion 702 also includes a “RECORD” action button that triggers not only recording of video from the video camera, but also recording of a presentation. When selected, the “RECORD” action button triggers the recording and becomes a “STOP RECORDING” action button which may be selected to conclude recording of the presentation. If the presenter does not want to record video, the presenter may select the “TURN OFF VIDEO” action button to stop recording to the video, but keep recording the presentation. The same action button may be selected again to turn the video back on.

As the presentation is being recorded, the presenter may select content, such as slide images, video, and other media content, in the playlist portion 708. The selected content will be displayed in the content viewing portion 706. The selections of the presenter and a time within the video recording are captured and recorded in a presentation configuration data structure, such as is illustrated in FIG. 8. This data structure, as will be discussed below, includes data that identifies a recorded video, data from the greeting portion 704, and content selected for display in the content viewing portion and a time within the video to display the selected content.

The greeting portion 704, through selection of the “UPDATE GREETING” action button allows the presenter to enter various data elements. Such data elements may include an identity of the presenter, contact information, a greeting message, and other data for display when the recorded presentation is played back.

FIG. 8 is a data structure 800 illustration according to an example embodiment. The data structure 800 is generated by a presenter and includes configuration data to be consumed by a browser plug-in when playing back a recorded presentation. The data structure includes data to display in a greeting portion, data identifying a video file, data identifying slide files to display and when with reference to a time within the video file. The data structure 800 may be downloaded from a web server and instructs a browser plug-in, when executing browser plug-in code as discussed above with regard to FIG. 1, to download and display various content elements.

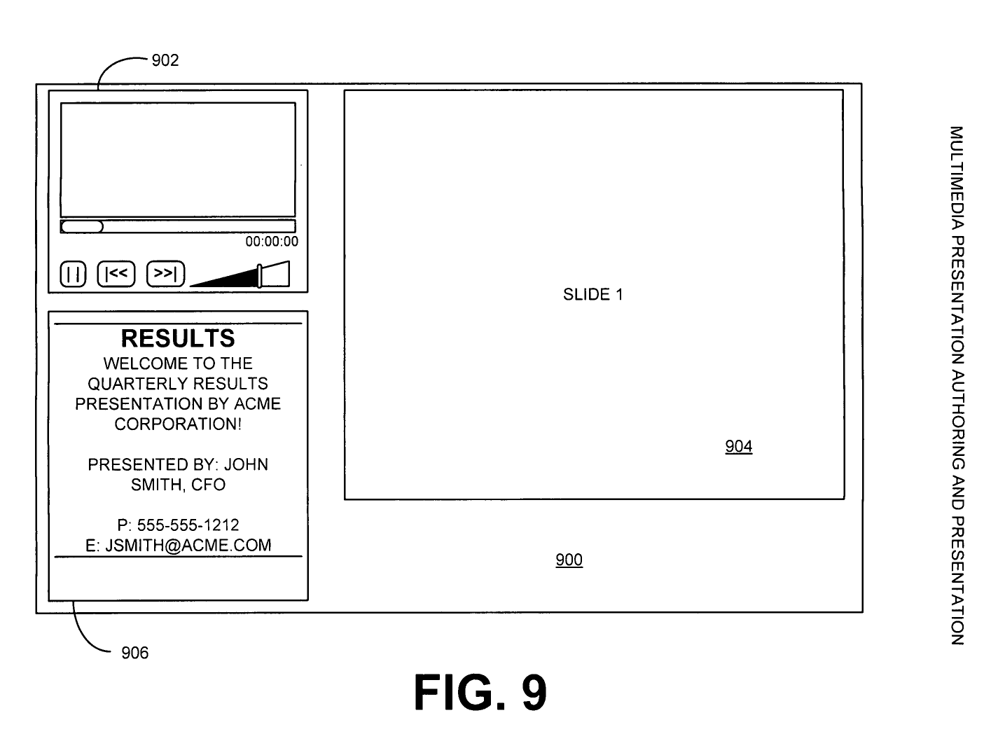

FIG. 9 is a user interface 900 illustration according to an example embodiment. The user interface 900 is a user interface of a presentation viewer. The user interface 900 may be instantiated on a client computing device of a viewer within a web browser through use of a browser plug-in, such as the Flash Player plug-in. The user interface 900, in some embodiments, consumes a data structure, such as the data structure 800 of FIG. 8, which identifies a video to show in a video viewing portion 902 of the user interface 900. The user interface 900 may also parse the data structure to identify content items to display within a content viewing portion 904 of the user interface 900. The content items may be displayed at times identified in the data structure with regard to a time in the video shown in the video viewing portion 902. The user interface 900 may also include a greeting portion 906 that displays greeting data included in the data structure.

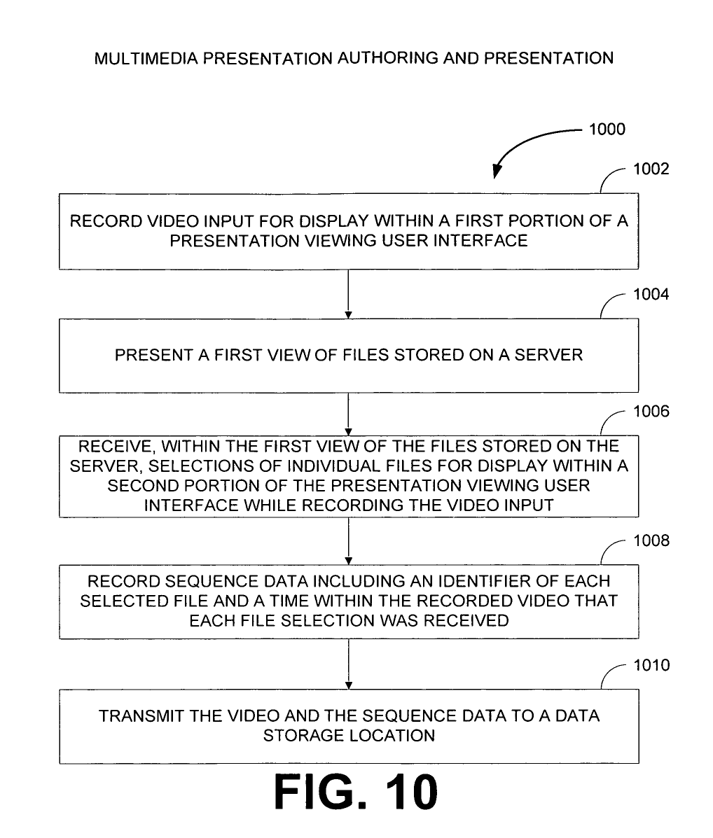

FIG. 10 is a block flow diagram of a method 100 according to an example embodiment. The method 1000 is a method of recording a presentation through use of a playlist. Selection of items in the playlist causes the selected item to be recorded for playback at a time in a recorded video. In some embodiments, the method 1000 includes recording 1002 video input for display within a first portion of a presentation viewing user interface and presenting 1004 a first view of files stored on a server. The first view, in typical embodiments, is a view of the playlist. The method 1000 further includes receiving 1006, within the first view of the files stored on the server, selections of individual files for display within a second portion of the presentation viewing user interface while recording the video input and recording 1008 sequence data including an identifier of each selected file and a time within the recorded video that each file selection was received. The method 100 may then include transmitting 1010 the video and the sequence data to a data storage location.

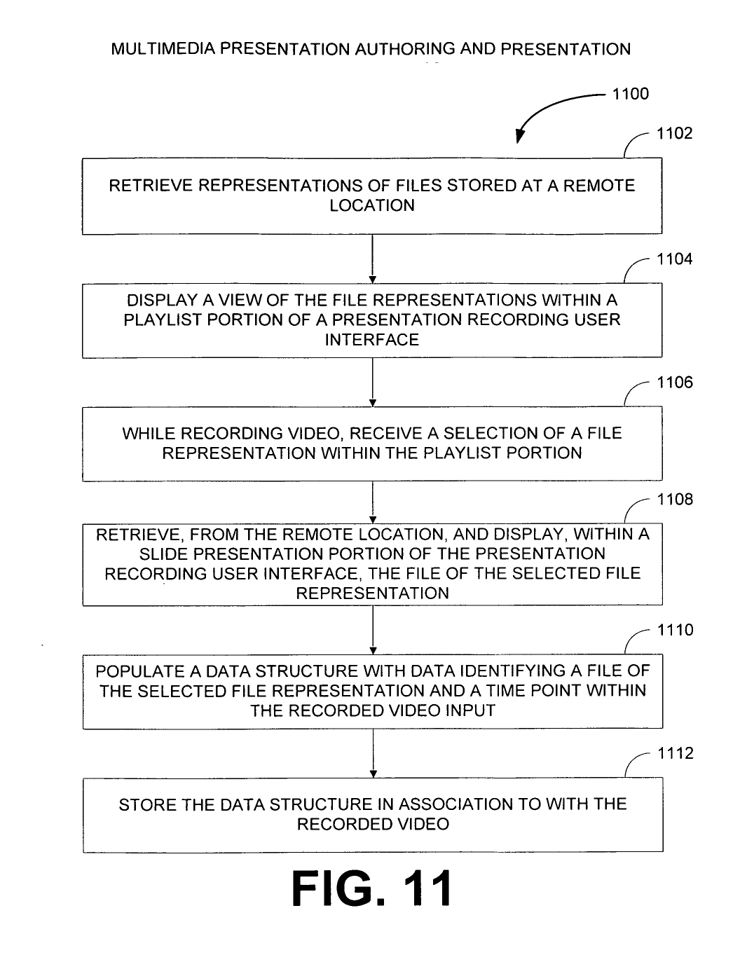

FIG. 11 is a block flow diagram of a method 1100 according to an example embodiment. The method 1100 is a method, according to some embodiments, of generating at least a portion of presentation data structure to synchronize a view of presented content with a recorded video of the presenter. The data structure and the video of the presenter, in typical embodiments, are captured simultaneously.

In some embodiments, the method 1100 includes retrieving 1102 representations of files stored at a remote location, such as a content database, and displaying 1104 a view of the file representations within a playlist portion of a presentation recording user interface. The method 1100, while recording video of a presenter, further includes receiving 1106 a selection of a file representation within the playlist portion and retrieving 1108, from the remote location, and displaying, within a slide presentation portion of the presentation recording user interface, the file of the selected file representation. The method 1100 may then include populating 1110 a data structure with data identifying a file of the selected file representation and a time point within the recorded video input. The data structure may then be stored 1112 in association to with the recorded video. In some embodiments, the data structure may be stored at the remote location.

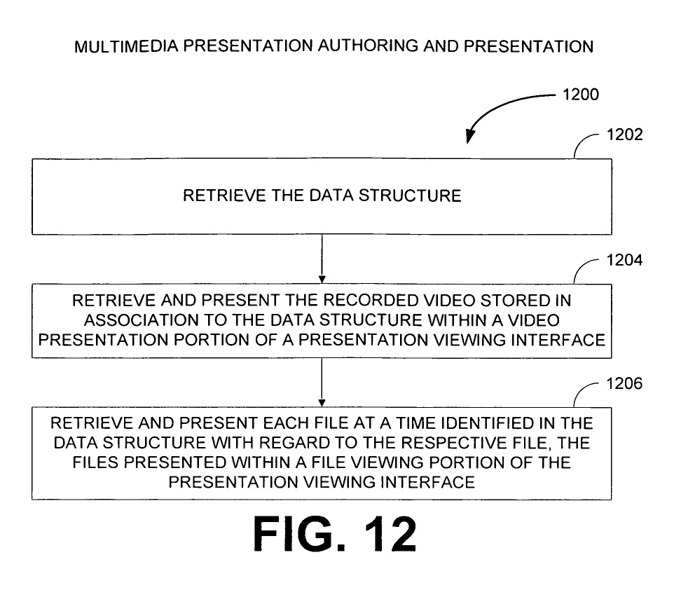

FIG. 12 is a block flow diagram of a method 1200 according to an example embodiment. The method 1200 is a method of playing back a recorded presentation using a data structure, such as a data structure generated according to the method 1100 of FIG. 11. The method 1200 includes retrieving 1202 the data structure and retrieving 1204 and presenting the recorded video stored in association to the data structure within a video presentation portion of a presentation viewing interface. The method 1200 further includes retrieving 1206 and presenting each file at a time identified in the data structure with regard to the respective file, the files presented within a file viewing portion of the presentation viewing interface.

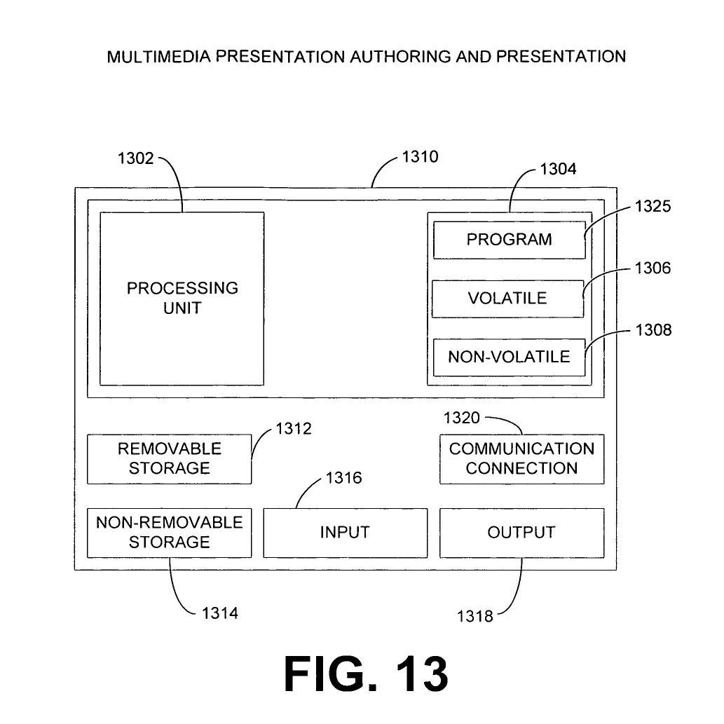

FIG. 13 is a block diagram of a computing device according to an example embodiment. In one embodiment, multiple such computer systems are utilized in a distributed network to implement multiple components in a transaction based environment. An object oriented, service oriented, or other architecture may be used to implement such functions and communicate between the multiple systems and components. One example computing device in the form of a computer 1310, may include a processing unit 1302, memory 1304, removable storage 1312, and non-removable storage 1314. Memory 1304 may include volatile memory 1306 and non-volatile memory 1308. Computer 1310 may include—or have access to a computing environment that includes—a variety of computer-readable media, such as volatile memory 1306 and non-volatile memory 1308, removable storage 1312 and non-removable storage 1314. Computer storage includes random access memory (RAM), read only memory (ROM), erasable programmable read-only memory (EPROM) & electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices, or any other medium capable of storing computer-readable instructions. Computer 1310 may include or have access to a computing environment that includes input 1316, output 1318, and a communication connection 1320. The computer may operate in a networked environment using a communication connection to connect to one or more remote computers, such as database servers. The remote computer may include a personal computer (PC), server, router, network PC, a peer device or other common network node, or the like. The communication connection may include a Local Area Network (LAN), a Wide Area Network (WAN), the Internet, or other networks.

Computer-readable instructions stored on a computer-readable medium are executable by the processing unit 1302 of the computer 1310. A hard drive, CD-ROM, and RAM are some examples of articles including a computer-readable medium on which software may be stored. For example, a computer program 1325, such as one or more of a web browser, web browser plug-in, and web browser plug-in executable code may be stored on a computer readable medium.

Some further embodiments may take the form of a system. Such embodiments, include a network interface, a processor, and a memory coupled to a bus. The memory, in such embodiments, may store media server software that is executable by the processor. The media server software may include a file upload module, a playlist module, and a recording module.

The file upload module may be executable by the processor to receive a file in a first file format over the network interface from a first client, transform the file from the first file format to a second file format, and store, in the memory, the file in the second file format.

The playlist module may executable by the processor to present a view of files stored in the memory and to receive input from the first client, over the network interface designating an order of the files stored in the memory. The playlist module may be further executable by the processor to present a selectable view, within a recording interface, of the files stored in the memory and ordered according to the received input.

The recording module may be executable by the processor to receive presentation data from the first client over the network interface. The presentation data may include video and sequence data identifying files stored in the memory with a time reference to the video at which particular files stored in the memory are to be displayed to a viewer. The recording module may also store the presentation data in the memory.

Such a system may further include web server software stored in the memory and executable by the processor to receive a presentation data request over the network interface from a second client and provide the video and the sequence data to the second client over the network interface. The web server software may be further executable by the processor to receive, from the second client over the network interface, requests for files stored in the memory that are referenced in the sequence data and provide the requested files to the second client.

It is emphasized that the Abstract is provided to comply with 37 C.F.R. §1.72(b) requiring an Abstract that will allow the reader to quickly ascertain the nature and gist of the technical disclosure. It is submitted with the understanding that it will not be used to interpret or limit the scope or meaning of the claims.

In the foregoing Detailed Description, various features are grouped together in a single embodiment to streamline the disclosure. This method of disclosure is not to be interpreted as reflecting an intention that the claimed embodiments of the inventive subject matter require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

It will be readily understood to those skilled in the art that various other changes in the details, material, and arrangements of the parts and method stages which have been described and illustrated in order to explain the nature of the inventive subject matter may be made without departing from the principles and scope of the inventive subject matter as expressed in the subjoined claims.

What is claimed is:

1. A system comprising:
a network interface coupled to a bus;
a memory coupled to the bus;
a processor coupled to the bus; and
media server software stored in the memory and executable by the processor, the media server software including:
a file upload module executable by the processor to:
receive a file in a first file format over the network interface from a first client;
transform the file from the first file format to a second file format; and
store, in the memory, the file in the second file format;
a playlist module executable by the processor to:
present a view of files stored in the memory;
receive input from the first client, over the network interface designating an order of the files stored in the memory; and
present a selectable view, within a recording interface, of the files stored in the memory and ordered according to the received input;
a recording module operable on the processor to:
receive presentation data from the first client over the network interface, the presentation data including video and sequence data identifying files stored in the memory with a time reference to the video at which particular files stored in the memory are to be displayed to a viewer; and
store the presentation data in the memory.

2. The system of claim 1, wherein;
the first file format of the file received within the file upload module is a slide-based presentation-type file; and
the file upload module is executable by the processor to transform each slide of the file to the second file format, each slide being an individual file.

3. The system of claim 1, further comprising:
web server software stored in the memory and executable by the processor to:
receive a presentation data request over the network interface from a second client;
provide the video and the sequence data to the second client over the network interface;
receive, from the second client over the network interface, requests for files stored in the memory that are referenced in the sequence data; and
provide the requested files to the second client.

4. A method comprising:
recording video input for display within a first portion of a presentation viewing user interface;
presenting a first view of files stored on a server;
receiving, within the first view of the files stored on the server, selections of individual files for display within a second portion of the presentation viewing user interface while recording the video input;
recording sequence data including an identifier of each selected file and a time within the recorded video that each file selection was received; and
transmitting the video and the sequence data to a data storage location.

5. The method of claim 4, wherein the files stored on the server include one or more of image files, animation files, and video files.

6. The method of claim 4, wherein the data storage location is the server.

7. The method of claim 4, further comprising:
presenting a user interface operable to receive a selection of one or more files for upload to the server.

8. The method of claim 4, further comprising:
presenting a second view of the files stored on the server; and
receiving, within the second view, sorting input setting an order of the files when presented in the first view.

9. A computer-readable medium, with instruction thereon, which when executed cause a computer to:
retrieve representations of files stored at a remote location;
display a view of the file representations within a playlist portion of a presentation recording user interface;
while recording video, receive a selection of a file representation within the playlist portion;
retrieve, from the remote location, and display, within a slide presentation portion of the presentation recording user interface, the file of the selected file representation;
populate a data structure with data identifying a file of the selected file representation and a time point within the recorded video input; and
store the data structure in association to with the recorded video.

10. The computer-readable medium of claim 9, with further instructions thereon, which when executed cause the computer to:
retrieve the data structure;
retrieve and present the recorded video stored in association to the data structure within a video presentation portion of a presentation viewing interface; and
retrieve and present each file at a time identified in the data structure with regard to the respective file, the files presented within a file viewing portion of the presentation viewing interface.

11. The computer-readable medium of claim 10, wherein the presentation viewing interface is an interface instantiated within a web browser plug-in.

12. The computer-readable medium of claim 9, wherein at least one received file selection in the playlist portion of the presentation recording user interface is a video file.

13. The computer-readable medium of claim 9, wherein the data structure includes a reference to the recorded video.

14. The computer-readable medium of claim 9, wherein the data structure further includes metadata descriptive of one or more of:
A presenter viewable in the recorded video; and
a description of the presentation.

15. A system comprising:
a web server, coupled to a network, the server including a moderator module;
the moderator module stored and operable on the server to:
present presentation administrative options to a user within a web browser, the administrative options including a playlist option, the playlist option, when selected, operable to:
provide a browser based interface including a listing of media files available on the web server, the interface further operable to allow:
sorting of the media files;
uploading of additional media files; and
deletion of media files present on the web server.

16. The system of claim 15, wherein upon receipt of an uploaded file to the playlist via the browser based interface, the moderator module is operative to:
convert one or more uploaded additional media files to a format capable of display within a browser-based media player.

17. The system of claim 16, wherein the browser-based media player is a Flash Player.

18. The system of claim 15, wherein the moderator module is further operable to:
present a playlist of files contained in the listing of media files available on the web server to a user, the playlist sorted according to any sorting of the media files received through the browser-based interface, wherein content of the media files included in the playlist are selectable for play via a set of controls.

19. The system of claim 18, wherein the set of control include one or more controls to play, rewind, fast forward, and skip media files forward and backward with respect to an order of the media files in the playlist.

20. The system of claim 18, wherein the moderator module is further operable to:
record a presentation into new media file, the recorded presentation including content of the media files available on and uploaded to the web server played according to a function of one or more of the set of controls.
